(19) United States
(12) Patent Application Publication
(10) Pub. No.: US 2006/0217824 A1
(43) Pub. Date: Sep. 28, 2006

(54) Fraud, abuse, and error detection in transactional pharmacy claims

(76) Inventors: Andrea L. Allmon, San Diego, CA (US); Jean De Traversay, Solana Beach, CA (US); Craig Nies, Carlsbad, CA (US); Anu Kumar Pathria, San Diego, CA (US); Phuong Nguyen, San Diego, CA (US); Nallan Suresh, Irvine, CA (US); Michael K. Tyler, San Diego, CA (US)

Correspondence Address: GLENN PATENT GROUP, 3475 EDISON WAY, SUITE L, MENLO PARK, CA, 94025, US

(21) Appl. No.: 11/361,473

(22) Filed: Feb. 23, 2006

Related U.S. Application Data
(60) Provisional application No. 60/656,798, filed on Feb. 25, 2005.

(51) Int. Cl. G06F 17/00

(52) U.S. Cl. 700/90

(57) ABSTRACT

A computer-implemented approach for processing benefits payment claims for prescription medicine, with these operations. Receiving pending pharmacy benefits payment claims submitted for payment by a pharmacy benefits claims payor, each claim specifying a patient. For each claim and its specified patient, performing operations including the following. Performing computer-driven statistical analysis of predefined aspects of one of the following in relation to a compiled history of past claims paid by one or more pharmacy benefits claims payors: claims history for the patient, the claim, medical history of the patient. Generating an indicator of predicted legitimacy by scoring results of the statistical analysis. Providing an output of at least one of the following: the indicator, payment advice prepared by applying predefined criteria to data including the indicator.

### CROSS-REFERENCE TO RELATED APPLICATIONS

This application claims the benefit of the following earlier-filed U.S. Provisional Application in accordance 35 USC 119. Application No. 60/656,798 entitled “Fraud, Abuse and Error Detection in Transactional Pharmacy Claims,” filed on Feb. 25, 2005 in the names of Suresh et al. The foregoing application is incorporated herein by reference.

### BACKGROUND OF THE INVENTION

1. Field of the Invention

The present invention relates to a computer-driven fraud, abuse, and error detection and reporting system for transactional pharmacy benefits claims. More particularly, the invention performs statistical analysis of predefined aspects of patient-drug history in relation to a compiled history of past claims paid, and generates an indicator of predicted legitimacy of individual claims by scoring results of the statistical analysis.

2. Description of the Related Art

In recent years, healthcare insurers have achieved a high level of speed and accuracy in processing claims. About 70% of claims are paid within two weeks of receipt and about 90% are paid within three weeks. Accuracy rates of 99.9% are common across the industry.

Ironically, insurers process a significant portion of these claims too quickly. Indeed, many should never be paid at all. A recent audit of $191.8 billion of Medicare fee-for-service claims payments revealed that 6.3% ($12.1 billion) were illegitimate or inappropriate. Industry-wide in the U.S., estimates of fraud losses range from 3% to 10% of every healthcare dollar.

There are a number of reasons why payors have not been able to curb these losses. One contributing factor has been health care companies' scramble to comply with laws requiring them to pay promptly. Accuracy has suffered in the name of speed. These laws require claims to be paid within specified time ranges, and there are stiff penalties for noncompliance. It is rarely an option to delay processing in favor of more in-depth fraud, error, and abuse detection.

Another reason for the healthcare payors' losses is the loopholes in today's complex reimbursement methodologies. These present opportunities for billing and policy errors to slip by claims audit systems. In some cases, criminals intentionally exploit these loopholes.

A particularly acute problem is with pharmacy transactions, since these are often point-of-sale transactions sometimes requiring the benefits company to review and approve benefits in real-time. With the increasing speed of paying pharmacy claims, then, there has been a similar increase in paying unwarranted claims. For instance, a benefits company might inadvertently pay for medicine that was not covered by the insured's plan. Or, the benefits company might pay for medicine for a person whose insurance has lapsed. Plus, pharmacy claims could be submitted with inadvertent errors that may cause the benefits company to overpay. In other cases, the benefits company might make payment for an undeserving claim that is actually sought by fraud. Within these variations is the common thread of a pharmacy benefits company paying for an improper claim, or paying a claim improperly. Consequently, pharmacy benefits companies are faced with an artificially increased cost of doing business, because they are making payments unnecessarily.

People have developed some techniques to address this problem. Most payors use post-payment detection, namely, analyzing already-paid claims to identify improper payment. Once payment has been made, however, it can be difficult to recoup losses. Post payment investigation and recovery are costly processes, and months or years may elapse before the payor receives any money back. In 2001, for example, federal and state government agencies recovered only $1.6 billion of the estimated $12 billion lost to Medicare billing fraud and error. Furthermore, since post-payment analysis has its own costs, it is only warranted when the total dollar amount of improper payments is significant.

Others have attempted rudimentary pre-payment techniques. One such technique is to conduct a manual or automated cross check of the benefits before payment. Namely, administrative staff manually cross-reference the requested benefits payment against eligibility and other records to verify that the payment should be made. However, this is time consuming, and with pharmacy transactions being mostly point of sale, this approach cannot afford to be very comprehensive within the required time frame.

In another example, clinical domain experts manually generate a set of rules, which are input into a computer and applied to pharmacy transactions. For example, one such rule might prevent payment of a patient's claim for Insulin and Pioglitazone, since this combination presents an increased risk of fluid retention and heart failure. The rule that prevents such payment assumes that the prescription for one of these drugs must obviously be in error. These systems generally focus on harmful drug interactions.

Although the rules-based approach might be better than nothing, there are a number of unsolved problems. First, manually creating such rules is time consuming and prone to error because the rules creator cannot possibly envision all possible scenarios and schemes of error, fraud, and abuse. Second, manually created rules are static and easily circumvented by skillful criminals with a mind to defeat them. Third, while a conventional rule-based system could conceivably invoke numerous rules, at any moment in time it analyzes a very limited amount of data, and suffers from not being able to see the complete picture. Fourth, one aspect of many of these rules based approaches is that violations must be definite. A pair of drugs that should never occur together can be automatically denied. While a pair of drugs which rarely occur together may indicate fraud, most rules systems ignore cases where the distinction is not black and white. Finally, since rules-based systems focus on known patterns, they are incapable of detecting never-before-seen patterns. People cannot write rules to cover an unknown situation.

Accordingly, there is no entirely satisfactory solution for pharmacy benefits companies seeking to promptly pay worthy claims but to detect and avoid paying non-meritorious claims with equal promptness.

### SUMMARY OF THE INVENTION

Broadly, this disclosure concerns a computer-implemented approach for processing benefits payment claims for prescription medicine, with these operations. Receiving pending pharmacy benefits payment claims submitted for payment by a pharmacy benefits claims payor, each claim specifying a patient. For each claim and its specified patient, performing operations including the following. Performing computer-driven statistical analysis of predefined aspects of one of the following in relation to a compiled history of past claims paid by one or more pharmacy benefits claims payors: claims history for the patient, the claim, medical history of the patient. Generating an indicator of predicted legitimacy by scoring results of the statistical analysis. Providing an output of at least one of the following: the indicator, payment advice prepared by applying predefined criteria to data including the indicator.

The teachings of this disclosure may be implemented as a method, apparatus, logic circuit, signal bearing medium, or a combination of these. This disclosure provides a number of other advantages and benefits, which should be apparent from the following description.

### BRIEF DESCRIPTION OF THE DRAWINGS

FIG. 1 is a block diagram of the hardware components and interconnections of a fraud, abuse, and error detection and reporting system for transactional pharmacy benefits claims.

FIG. 2 is a block diagram of a digital data processing machine.

FIG. 3 shows an exemplary signal-bearing medium.

FIG. 4 is perspective view of exemplary logic circuitry.

FIG. 5 is a flowchart depicting the operation an exemplary fraud, abuse, and error detection system for transactional pharmacy benefits claims.

### DETAILED DESCRIPTION

The nature, objectives, and advantages of the invention will become more apparent to those skilled in the art after considering the following detailed description in connection with the accompanying drawings.

### Hardware Components & Interconnections

Overall Structure

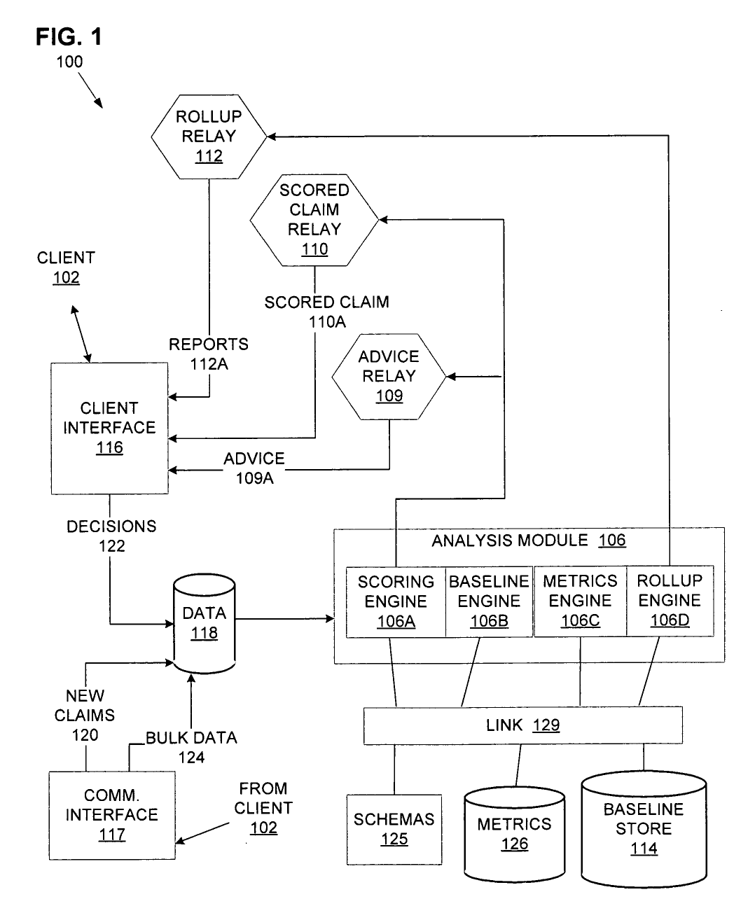

One aspect of the present disclosure concerns a fraud, abuse, and error detection system for transactional pharmacy benefits claims. This system may be embodied by various hardware components and interconnections, with one example being described by the system 100 of FIG. 1.

As shown in the following description, the system 100 is operated on behalf of a client 102, which is a pharmacy benefits claims payor. In this example, the client 102 is an insurance company, intermediary, broker, or other pharmacy benefits payor, including Pharmacy Benefit Managers. Some examples might include companies like BlueShield, PacifiCare, Wellmark, Prescription Solutions, etc. The system 100 may be operated by the client 102 itself, or operated by a third party on behalf of the client 102. The client 102 is not actually part of the system 100, but merely shown for completeness of illustration.

The system 100 may be implemented in different settings with respect to the client 102. In one example, the system 100 represents an outside service provided to the client 102 on a fee basis. The fee-for-service company maintains hardware of the system 100 on-site at the client 102 or at a remote location with respect to the client 102. In a different example (not shown), the pharmacy benefits payor maintains the system 100 internally; in this example, appearances of the “client 102” in FIG. 1 would be replaced by finance officers, computer operators, data entry personnel, or other appropriate administrative staff of the pharmacy benefits payor that utilize information output by the system 100.

Major components of the system 100 include an analysis module 106, schemas 125, metrics 126, baseline store 114, data store 118, rollup relay 112, scored claim relay 110, advice relay 109, client interface 116, and communications interface 117. The system 100 also includes an interface, console, input/output, or other facility (not shown) for secure access to the system 100 components by system administrators, programmers, data entry personnel, or other staff of the entity that operates the system 100.

The analysis module 106 comprises digital data processing equipment, and more particularly, it includes a scoring engine 106a, baseline engine 106b, metrics engine 106c, and rollup engine 106d.

Broadly, the baseline engine 106b generates baseline data (114) by analyzing a compiled history of past claims paid by one or more pharmacy benefits payors and producing a statistical ranking according to this analysis. The analysis is conducted according to certain criteria, and more particular, the schemas 125 described below. As discussed in greater detail below, the metrics engine 106c generates certain metrics quantitatively describing characteristics of patient-drug history as specified by predefined schemas 125. The metrics 126, schemas 125, and their creation and use are discussed in greater detail below. The scoring engine 106a compares metrics 126 computed for a particular patient-drug claim to the compiled claims history and statistically ranks the metrics according to this comparison.

The rollup engine 106d provides rollup reports each containing summary information for a prescriber, patient, pharmacy, or other entity regarding number and type of suspicious claims associated with the entity. Rollup reports, along with the detailed operation of the components 106a-106d, are described in detail below.

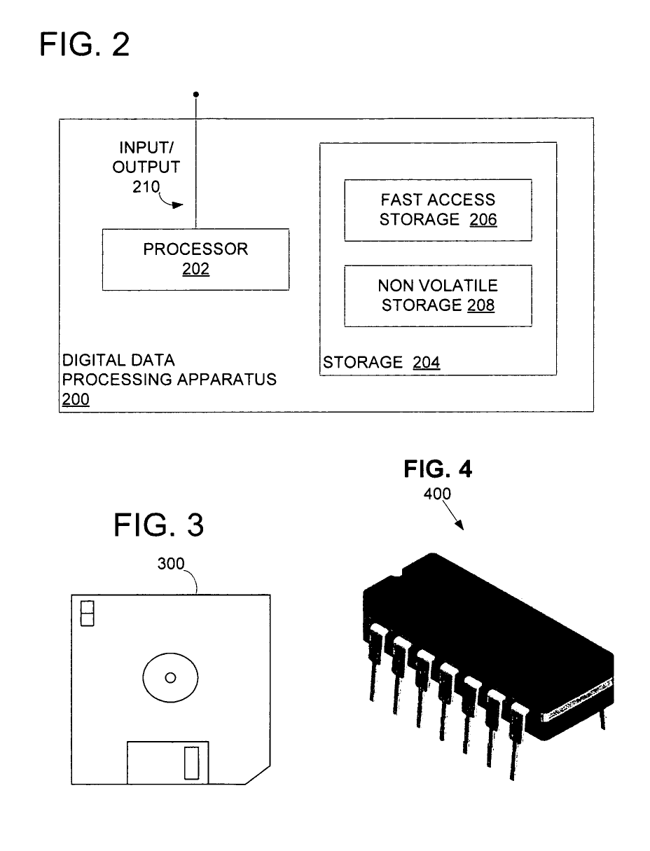

Broadly, the functional entities of the system 100, such as the engines 106a-106d, may be implemented by one or more hardware devices, software devices, a portion of one or more hardware or software devices, or a combination of the foregoing. The makeup of these subcomponents is described in greater detail below, with reference to an exemplary digital data processing apparatus (FIG. 2), signal bearing medium (FIG. 3), and logic circuit (FIG. 4).

The baseline store 114 provides machine-readable digital data storage to store certain baseline claims data summaries as discussed in greater detail below. In one example, this storage device 114 is implemented by a Network Appliance FAS3000 series storage server, where the baseline data 114 is implemented by one or more ORACLE or other relational database tables collectively referred to as a “risk table.” However, the baseline store 114 may be implemented by a variety of different storage arrangements including direct access storage (e.g., a conventional “hard drive”, redundant array of inexpensive disks (“RAID”), or another direct access storage device (“DASD”)), serial-access storage such as magnetic or optical tape, electronic non-volatile memory (e.g., ROM, EPROM, flash PROM, or EEPROM), battery backup RAM, optical storage (e.g., CD-ROM, WORM, DVD, digital optical tape), or any other compute-readable storage media.

Like the baseline store 114, the metrics 126 and schemas 125 represent machine-readable digital data storage containing various data structures. Depending upon the application details, some or all of the components 125, 126, 114 may be implemented in the same storage device.

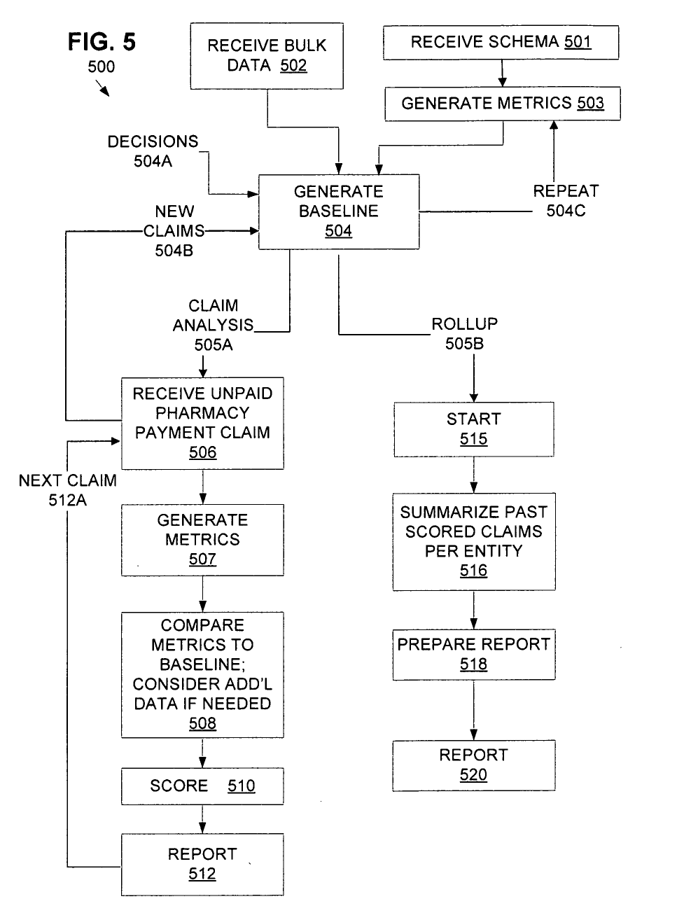

The components 125, 126, 114 are coupled to the analysis module 106 via link 129. The link 129 comprises a general purpose interface such as a communications bus, wireless or wired local or wide area network, Internet, etc. Alternatively, the link 129 may comprise hardwired connections specifically interconnecting those of components 106a-106d and 125, 126, 114 that require interconnection according to their functional roles as described below (FIG. 5).

The data store 118 provides storage to receive and store data from the client. In the illustrated example, some data 120, 124 arrives via the communication interface 117 and other data 122 arrives from the client interface 116. Data contained in the store 118 is therefore available, as needed, for retrieval by the engines 106a-106d. The store 118 may be implemented by a variety of storage devices, such as those examples described above in conjunction with the baseline store 114.

The scored claim relay 110 assists in relaying scored claims from the scoring engine 106a to the client 102. In one example, the relay 110 comprises a queue, implemented by storage to receive, store, and output pharmacy benefits payment claims scored by the engine 106a. The relay 110 may be implemented by a variety of storage devices, such as those examples described above in conjunction with the baseline data 114. In another embodiment, the relay 110 provides a fiber optic, Internet, hardwire, wireless RF, satellite, telephone, or other link to directly convey scored claims to the client 102 without queuing.

The rollup relay 112 assists in relaying rollup reports from the rollup engine 106d to the client 102. Similarly, the advice relay 109 assists in relaying payment advice 109a from the scoring engine 106a to the client 102. The relays 112, 109 may be implemented by similar components as the relay 110.

The client interface 116, in one example, comprises a computer server that provides one or more worldwide web pages accessible by Internet web browsers. Beyond this example, however, the interface 116 may be implemented by any server, computer workstation, personal computer, mainframe computer, or other computing device adequate to perform the required functions of this disclosure. As illustrated, the interface 116 provides a worldwide web interface between the client 102 and the rollup/entity reports 112a, scored claims 110a, and advice 109a from the respective components of the analysis module 106. In one embodiment, the interface 116 encourages security by using encryption and by requiring that the client 102 provide security credentials such as user name and login password, digital certificate, security card, biometric identification, etc.

In addition to providing output to the client 102, the interface 116 also receives input from the client 102. As discussed in greater detail below, the client 102, when reviewing each claim which is suspicious enough to be queued in relay 110, submits a decision as to whether to pay the claim or not. The interface 116 receives these decisions (122) and forwards them for storage in the data store 118. The interface 116 may also forward (not shown) these decisions to the client 102's internal payment system.

The communications interface 117 provides another link between the system 100 and the client 102. In one example, the interface 117 is a buffered modem that provides an FTP interface by which the client 102 can submit digital data to the system 100. More broadly, however, the interface 117 may be implemented by a modem, demodulator, receiver, router, or any number of different products or systems to receive the client 102's digital data as described more completely below. In the illustrated example, the interface 117 receives new claims 120 and bulk data 124 from the client 102, and forwards these to the data store 118. New claims 120 represent unpaid individual pharmacy benefits claims, whereas bulk data 124 represents a history of past claims paid. In another example, the interface 117 may be integrated into the interface 116.

Exemplary Digital Data Processing Apparatus

As mentioned above, the data processing features of the analysis module 106, interfaces 116-117, and the like may be implemented in various forms. As one example, one or more digital data processing apparatuses may be used, as exemplified by the hardware components and interconnections of the digital data processing apparatus 200 of FIG. 2.

The apparatus 200 includes a processor 202, such as a microprocessor, personal computer, workstation, controller, microcontroller, state machine, or other processing machine, coupled to storage 204. In the present example, the storage 204 includes a fast-access storage 206, as well as nonvolatile storage 208. The fast-access storage 206 may comprise random access memory (“RAM”), and may be used to store the programming instructions executed by the processor 202. The nonvolatile storage 208 may comprise, for example, battery backup RAM, EEPROM, flash PROM, one or more magnetic data storage disks such as a “hard drive”, a tape drive, or any other suitable storage device. The apparatus 200 also includes an input/output 210, such as a line, bus, cable, electromagnetic link, or other means for the processor 202 to exchange data with other hardware external to the apparatus 200.

Despite the specific foregoing description, ordinarily skilled artisans (having the benefit of this disclosure) will recognize that the apparatus discussed above may be implemented in a machine of different construction, without departing from the scope of the invention. As a specific example, one of the components 206, 208 may be eliminated; furthermore, the storage 204, 206, and/or 208 may be provided on-board the processor 202, or even provided externally to the apparatus 200.

Signal-Bearing Media

In carrying out the data processing features of the system 100, one option is to employ computer-readable signal-bearing media in conjunction with some or all of these. Such media tangibly embody a program of machine-readable instructions executable by a digital processing apparatus such as that of FIG. 2. In one example, the machine-readable instructions are executable to carry out various functions related to this disclosure, such as the operations described in greater detail below. In another example, the instructions upon execution serve to install a software program upon a computer, where such software program is independently executable to perform other functions related to this disclosure, such as the operations described below.

In any case, the signal-bearing media may take various forms. In the context of FIG. 2, such a signal-bearing media may comprise, for example, the storage 204 or another signal-bearing media, such as a magnetic data storage diskette 300 (FIG. 3), directly or indirectly accessible by a processor 202. Whether contained in the storage 206, diskette 300, or elsewhere, the instructions may be stored on a variety of machine-readable data storage media. Some examples include direct access storage (e.g., a conventional “hard drive”, redundant array of inexpensive disks (“RAID”), or another direct access storage device (“DASD”)), serial-access storage such as magnetic or optical tape, electronic non-volatile memory (e.g., ROM, EPROM, flash PROM, or EEPROM), battery backup RAM, optical storage (e.g., CD-ROM, WORM, DVD, digital optical tape), or other suitable computer-readable media.

Logic Circuitry

In contrast to the signal-bearing media and digital data processing apparatus discussed above, a different option is to use logic circuitry instead of computer-executed instructions to implement some or all of the data processing features of the system 100.

Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS, TTL, VLSI, or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like. FIG. 4 shows an example of logic circuitry in the form of an integrated circuit 400.

### Operation

Having described the structural features of the present disclosure, the operational aspect of the disclosure will now be described.

Overall Sequence of Operation

FIG. 5 shows a sequence 500 to illustrate one example of the method aspect of this disclosure. Broadly, the sequence 500 performs statistical analysis of information such as patient claims history or the claim itself in relation to a compiled history of past claims paid, and generates an indicator of predicted legitimacy of individual claims by scoring results of the statistical analysis.

For ease of explanation, but without any intended limitation, the example of FIG. 5 is described in the specific context of the system 100 of FIG. 1 where a fee-for-service entity (not shown) operates the system 100 on behalf of a client entity 102. Referring to FIGS. 1 and 5, the system 100 receives bulk data 124 in step 502. In one example, the bulk data 124 is received from the client 102 via FTP server embodied by the interface 117. In other examples, the bulk data 124 may be received from the client 102 via U.S. mail, courier, package delivery service, facsimile, email, worldwide web site, secure HTTPS download by the interface 117, or any other service adequate to convey the bulk data 124.

Generally, the bulk data 124 includes a record of many claims paid by the pharmacy benefits payor (i.e., client 102) in the past. The bulk data 502 may include further data such as eligibility information, specifying which patients are eligible for pharmacy benefits and under which circumstances. If available, the bulk data 502 may include the medical history for various patients enrolled for benefits with the client 102. The bulk data in 502 may also contain data on pharmacies which are eligible for reimbursement, or data related to specific drugs, including drug labels and grouping schemes. Although the bulk data 124 initially provided by a client 102 need not limited to a particular time frame, one year's worth of historical data may prove sufficient for many cases. If convenient data gathering permits, however, the bulk data 124 may include all claims paid regardless of time frame, or as many as available. Advantageously, the system 100 need only receive the bulk data 124 once, for example, when the client 102 is added to the system 100 or when system 100 is initialized, installed, reconfigured, etc.

As to claims payment records occurring in the bulk data 124, the contents of an exemplary record may include some or all of the following:
Patient's identifying information.
Amount paid.
Amount billed by the pharmacy.
Type of medicine, for example, national drug code (or “NDC” number).
Dosage size, dosage frequency, duration of prescription.
Identity of prescribing doctor.
Identity of pharmacy that fulfilled the order.
Claim identifier for future investigation.
Refill status.
Preauthorization information.
Various other relevant attributes to aid in claim review.

Although receipt of the bulk data 124 (step 502) is described as originating from the client 102, the system 100 may actively collect bulk data 124, and further may gather data from other sources such as different pharmacy benefits claims payors than the client 102, the Internet, published reports, pharmacy records, health institution records, prescriber's records, a healthcare network, a medical benefits payor, a pharmacy benefit manager, or a pharmacy data clearinghouse.

In step 501, the system 100 receives one or more schemas into the storage 125. The schemas 125 may also be called “designs” or “plans” and each schema represents a paradigm or model for a specific set of metrics 126. Broadly, each schema 125 defines a feature of prescription benefits claims to be evaluated against other claims, as described below. Each schema may be based on a single claim being evaluated, or based on that claim in combination with a historical set of claims. One exemplary schema is “rate of drug use.” Rate of drug use takes into account the amount of drugs dispensed on the current claim, and the amount dispensed on previous claims, to find a rate of drug use over time.

In one example, technicians hand-generate the schemas of step 501 based upon logical reasoning, known pharmacy benefits claims that were improperly paid, known patterns of fraud or error or abuse, and other considerations. The following represent some exemplary schemas of step 501, as would be used to generate metrics applied to a given pharmacy benefits claim as discussed in greater detail below:
The occurrence of concurrent prescriptions for a given combination of drugs.
A patient visiting multiple pharmacies in the same day.
The prescribing of a given drug and dosage size, frequency, and/or duration.
Dollars paid for a given amount of a given drug.
The occurrence of concurrent prescriptions for drugs in the same therapeutic class.
A patient receiving a large quantity of drugs on single day, potentially including one or many different medicines.
A patient receiving prescriptions from multiple prescribers for a single medicine.
Occurrence of situations where the number of days for which a drug has been dispensed exceeds that time period over which the drug has been supplied.
Amount of daily supply in relation to the quantity supplied and the drug.
Number of prescribers and pharmacies associated with a given patient-drug pair.
The rate (quantity per time) for which a given drug is dispensed.
Continuous time-duration over which a given drug is supplied to a given patient.
The occurrence of a patient receiving prescription for a drug and concurrently or previously exhibiting a given medical condition.

In a specific operational example utilized throughout the following description, the operations 500 may be performed with a limited set of schemas as follows: (1) rate drug use, such as the number of milligrams per day or another measure of the rate at which the patient takes a drug, (2) total expense of all medicines prescribed by a patient per day, (3) occurrence of prescriptions for medicines in same therapeutic class, (4) expense of patient's prescription, (5) the use of multiple pharmacies or multiple prescribers, and (6) excess supply of a drug over a period of time.

As mentioned above, one exemplary schema is “rate of drug use.” With rate of drug use initially specified as a schema (step 501), later steps of the sequence 500 consider the historical rate of drug use for the particular patient-drug involved in the pending pharmacy benefits claim and compare this to the rate of drug use for all claims at large for this drug. As described below, the pending pharmacy benefits claim is scored by considering how the current patient's historical rate of using this drug compares to the entire available body of past claims involving the same medicine, thereby detecting fraud, error, or abuse.

After step 501, the metrics engine 106c processes the schemas 125 in order to generate metrics 126 applicable to the bulk data 124 (step 503). Broadly, each metric 503 is the specific application of a schema to historical data such as the client data 118. Metrics are current as of any moment in time. Whereas a schema may broadly prescribe “rate of drug use” as a statistic of interest, the related metric is a number, and more specifically, lists a rate of drug use for each patient-drug combination at a given moment in time. Therefore, each schema's metric may include many pieces of data for many patients and drugs. In the example of the “rate of drug use” schema, the related metric indicates the rate of drug use for every patient-drug combination in the bulk data 118 received at 502. In step 503, then, the metrics engine 106c generates specific data answering the question posed by each of schema 125, for each patient-drug combination in the bulk data.

Although the present disclosure may optionally employ some rules, the use of schemas and metrics provides a broader and more powerful approach than specifying rules alone. To illustrate a rule, one example is a rule that flags all pharmacy benefits claims for the medicines Insulin and Pioglitazone. Since these drugs are known to counteract each other, this prescription is likely problematic, and may indicate some type of fraud, error, or abuse upon the pharmacy benefits payment system. Although the exemplary rule would reliably flag prescriptions for the specific combination of Insulin and Pioglitazone, this simple rule would miss other equally unlikely combinations such as Insulin and Rosiglitzone. In contrast, a sample schema applicable to the same situation, and more powerful still, might read as follows: prescriptions for multiple drugs that are rarely prescribed together are suspicious. For this and many other reasons, schemas and metrics provide a broader, more powerful, more comprehensive approach than merely specifying rules alone. The schema/metric approach also expands the universe of potential errors beyond simple clear cut cases. Rules are generally black and white; if the rule is violated, the claim is in error. By expanding beyond clear cut cases to identifying claims that are likely, but not necessarily, error, a broader range of erroneous claims can be identified.

In step 504, the system 100 generates baseline data 114. Broadly, in step 504, the baseline engine 106b compares the computed metrics from 503 to the compiled history of past claims paid (118) and produces a statistical ranking of the metrics 126 according to this comparison. Step 504 therefore condenses vast amounts of data into its essential informational value. In one example, step 504 may potentially condense trillions of bytes of data down to about one thousand or so meaningful numbers. Then, when the potential claim arrives (later in step 506, described below), this compact and efficient information package is accessible nearly instantaneously to analyze the new claim.

Initially, the body of claims analyzed in step 504 include some or all of the bulk data 124 (from step 502). The body of claims analyzed in 504 may further include claims paid by pharmacy benefits payors beyond the client 102, in the event such information is available. Optionally, the baseline data may be limited to a particular time frame, such as the past year. Or, to likely catch slow developing schemes of fraud, or patterns that have renewed after a number of years of absence, the baseline data 114 may have a broader or unlimited timeframe.

The baseline data 504 may be regenerated (504c, 503) as often as practicable in order to ensure that the new claims 504b and client decisions 504a are included in the baseline 114. In other words, when the baseline data is regenerated (as shown by step 504c), the body of claims to be analyzed include the bulk data as supplemented by new claims 504b and decisions 504a that the client 102 has made upon claims scored (510) and output (512) by the system 100 in the past. This helps ensure that evaluations are current, and helps to detect newly emerging schemes of fraud or abuse. Thus, with new data from incoming claims and decisions, the baseline can be dynamically updated. Day by day, or even second by second in the case of real-time operations, the mathematical descriptions of the baseline 114 become richer, more complete, and more accurate representations of legitimate and illegitimate care delivery and billing behavior patterns. In this sense, the baseline engine 106b is capable of learning.

Step 504 may utilize any number of different methods of statistical technique, as appropriate to the application, data, and other circumstances at hand. Specific methods include Bayesian techniques to address specific small sample problems, and some distributional assumptions appropriate to the types of metrics being created. More particularly, step 504 may involve computing the weighted mean of a statistic of interest and the expected value of the statistic. Step 504 may employ these or other methods, which are known to those of ordinarily skill in the art, in order to help ensure robustness in the scoring engine. Again, the baseline is generated (504) in order to gain statistical insight into how the historical data breaks down with respect to the metrics of 503.

After step 504, there are two separate program sequences, a claim analysis track 505a and a rollup track 505b. In the track 505a (steps 506-512), the scoring engine 106a analyzes individual, pending pharmacy benefits claims, and provides an output for use by the client 102 in deciding whether to pay the pending pharmacy benefits payment claims. In the track 505b (steps 515-520), the rollup engine 106d analyzes past claims paid data of the client 102, and provides various reports.

The track 505a is discussed first. In step 506, the system 100 receives a pending pharmacy benefits payment claim submitted by the client 102. In the illustrated example, the pharmacy benefits payment claim of step 506 represents a pharmacy's claim for payment of insurance benefits covering a patient's prescription medicine that a pharmacy has dispensed (or is in the process of dispensing). In this example, the client 102 submits the unpaid claim to the system 100 after the client 102 has reviewed the claim and approved it for payment.

In one example, the client 102 receives the following information in the pharmacy's payment claim, and forwards all of this information to the system 100 verbatim in step 506: (1) medicine to be dispensed, (2) amount billed for the medicine, (3) identity of patient receiving the medicine, (4) identity of pharmacy dispensing the drug, (5) duration of prescription, (6) prescribing doctor. Alternatively, the client 102 may add, subtract, or modify data before transmitting the pharmacy's claim in step 506.

More particularly, in the context of FIG. 1, step 506 is accomplished by the data store 118 receiving a new claim 120 via the communications interface 117. For example, in step 506 personnel of the client 102 may submit the claim by transmitting data via FTP interface 117. The claim being processed is referred to as the “current” claim. To give a specific example, the current claim received in step 506 may be as follows: a claim by Walgreens Store No. 8479 for payment of $83 for dispensing patient Helen Highwater a thirty day supply of Clarithromycin to be taken daily at the dosage of 20 mg.

Next, in steps 507-508 the system 100 analyzes the current claim in relation to the baseline data 114. Broadly, in these operations the metrics engine 106c and scoring engine 106a combine potentially hundreds or thousands of profile numbers from the baseline 114 with the current claim information in complex ways, looking at multiple relationships between many pieces of data simultaneously. This pattern recognition capability enables the model(s) to see how all the pieces form a unified picture of the fraud, abuse, or error risk of the claim.

More specifically, as to the patient-drug pair of the current claim, in step 507 the metrics engine 106c computes metrics 126 quantitatively describing characteristics (specified by the schemas 125) of the patient-drug history. In other words, step 507 generates updated metrics 126 specifically applicable to the patient-drug combination of the current claim. This is performed similar to step 503, as described above, except that it is limited to the current claim's patient-drug combination.

In the presently illustrated example, where a limited set of schemas are used as discussed above, step 507 computes metrics for the following six schemas: (1) rate of drug use, (2) total expense of all medicines prescribed by a patient per day, (3) occurrence of prescriptions for medicines in same therapeutic class, (4) expense of patient's prescription, (5) multiple pharmacies or multiple prescribers, and (6) excess supply of a drug over a period of time.

As to the exemplary claim of Helen Highwater, step 507 as an example may find that, for the “rate of drug use” schema, claims history indicates a rate of 17 mg. This is the metric for the “rate of drug use” schema in regard to the current claim. The computed metric in this case may be an average, mean, or other distillation of Helen's history of rate of drug use. As an example of a different metric in the case of exemplary patient Helen Highwater, step 507 may examine the metric “occurrence of prescriptions for medicines in the same therapeutic class.” Here, the metrics engine 106c obtains additional data by reviewing the historical claims paid data 118 for all past records of patient Helen Highwater, searching for whether Helen Highwater has any other current prescriptions for other drugs. In this example, the gathering of additional data reveals a previous paid prescription (still current) in Helen Highwater's name for Erythromycin. This completes the generation of the relevant metric (step 507) for the “prescriptions for medicines in the same therapeutic class” schema. Step 507 repeats in similar fashion to compute the relevant metrics for all remaining schemas as to the current patient.

In some cases, step 507 may modify some aspects of the submitted claim information before computing its metrics. For example, as to metrics such as excessive days supply of a medicine, the scoring engine 106a may ignore the two most recent prescriptions for a patient, thereby accounting an absolutely normal case where a person acquires extra meds before travel.

After 507, the scoring engine 106a compares the calculated metrics for the current patient (from 507) to the baseline data 114 in step 508. As to the rate of drug use metric, step 508 involves the scoring engine 106a comparing the current calculated metric (17 mg Clarithromycin per day) to the baseline data 114, which includes all patients in the historical data 118 with past or present prescriptions for Clarithromycin. In this example, step 508 finds that the 17 mg dosage of Clarithromycin in the baseline data's 48^{th} percentile.

As to the “occurrence of drugs in the same pharmaceutical class” metric, the scoring engine 106a finds that Helen's concurrent prescriptions for Clarithromycin and Erythromycin (i.e., the relevant metric) occur in the 5^{th} percentile (i.e., metric compared to baseline data). Patients rarely take these drugs concurrently because they are in the same therapeutic class.

In the same manner as discussed above, step 508 continues to evaluate the current claim as to the remaining metrics 507. Optionally, the analysis of step 508 may additionally implement one or more rules mandated by the client 102 or developed by the operators of the system 100. In any case, if the patient's history does not show prior claims for the current drug (i.e., no baseline data), or an actual rate of usage cannot be calculated (i.e., metrics are incalculable), then step 508 may skip scoring of this particular metric. On the other hand, without any baseline data for the patient-drug combination, step 508 may utilize the claim itself as the metric (e.g., 20 mg in this example).

In addition to step 508 as described above, the following technique may be used in scoring some claims. Namely, step 508 may operate to compare the specifics of the current claim (without regard to the patient's history/metrics) to the baseline data. This may be useful to detect claims that individually depart from the baseline data but where the patient-drug history (metrics) is not yet irregular.

After completing step 508, the scoring engine 106a generates an indication of predicted legitimacy of each claim in step 510. Namely, the engine 106a scores results of the statistical analysis of step 508. Broadly, each claim's score serves as an indicator for how well that claim compares to the baseline data 114. If a claim fares poorly, it is an indication there might be some fraud, abuse, or error in the transaction.

In one specific example, step 510 separately scores results of each metric/baseline comparison of step 508. Thus, in the example given above where there are six metrics, step 510 separately scores the current claim as to each of these six metrics. In a simple example, merely to illustrate the concept of scoring, individual claims are scored according to the following formula, for each metric: 20* ABS (50-percentile). This formula yields scores ranging from zero to one thousand, with zero being least suspect and one thousand indicating greatest likelihood of a problem. In actual implementation, recognizing that a high majority of claims are legitimate, this formula may be mathematically modified so that only the top 0.1 percent of claims score 950 or higher. As to the current claim example, and using the simplified formula from above, step 510 yields a score of 40 (for dosage size) and a score of 900 (for concurrent prescriptions for two drugs in the same therapeutic class).

Optionally, step 510 may further provide an overall or final score by combining the separate scores of each metric. In one example, the scoring engine 106a combines the separate scores by taking their maximum. Therefore, in the current example of patient Helen Highwater, the final score is the maximum of 40 and 900 and the scores for the other metrics (not discussed). Scores can be combined in many other ways as well, some of which may be apparent to ordinarily skilled artisans having the benefit of this disclosure.

In step 512, the scoring engine 106a prepares one or more reports based upon the score calculated in 510. In the present example, the scoring engine 106a also prepares advice 109a in the form of a payment recommendation, such as pay/no-pay, and forwards this client via the advice relay 109, along with a copy of the related claim (or other indicia to identify the claim, such as claim number, reference number, etc.). To provide some examples, the pay/no-pay recommendation may be given unless a claim scores above a predetermined number, or unless a claim scores above a certain percentile, etc.

In addition to the advice 109a, the scoring engine 106a also sends (step 512) a report 110a of the claim score to the client 102 via the relay 110. Alternatively, the system 100 may transmit the scored claim directly to the client 102 via U.S. mail, courier, package delivery service, facsimile, email, worldwide web site, secure HTTPS download by the interface 117, or any other service adequate to convey the information. In still another alternative, step 512 may provide claim scores in limited circumstances, such as where a claim scores poorly according to a given criteria.

Optionally, step 512 may take additional action in the event that a pending claim scores poorly. For claims with a “no-pay” recommendation, the scoring engine 106a may supplement the scoring report 110a with additional data to help the evaluator (at the client 102) in deciding whether to pay the claim. This supplemental data may include, for example, other claims for that patient on that day, or other claims for the patient for that drug. The data store 118 is one example of a source for supplemental information, but others may be employed.

Depending upon the requirements of the application, the comparison 508, scoring 510, and reporting 512 operations may be performed with minimal delay (such as one or two minutes), or even in real-time. In another example, the operations 508-512 may be performed in a batch mode where claims are aggregated (step 506) and processed (steps 508-512) overnight or according to another suitable schedule.

After step 512, the sequence 500 returns to step 506 to receive the next claim for analysis, as indicated by 512a. Then, the steps 507-512 are repeated for this next claim. Of course, the series depiction of steps 506-512 is for ease of illustration only, without any intended limitation. For example, in a multitasking-capable environment, the next performance of step 506 may commence before the last claim has finished processing.

Also occurring after step 512, the client 102 may take various actions that are not part of the system 100 and the sequence 500 but still merit discussion. For example, after step 512, the client 102 may conduct its own investigation of a poorly scored or flagged claim in order to prevent this and future losses. Furthermore, the client 102 approves or denies payment of the claim and utilizes the client interface 116 to notify the system 100 of the approval or denial decision (122/504a) so that such data (122/504a) can be incorporated into future baselines 114 (504c). Other post-reporting action by the client 102 may include gathering information for a potential audit, and targeting certain pharmacies, prescribers, or health care institutions for audit, education, and other forms of intervention.

As mentioned above, there were two separate program sequences after step 504, a claim analysis track 505a and a rollup track 505b. The preceding description addressed the track 505a. In the track 505b (steps 515-520), the scoring engine 106a analyzes past claims paid by of the client 102 and provides various reports. The sequence 515-520 is optional, however, and may be omitted without affecting the operability of the remaining aspects of the sequence 500.

The start (515) of the sequence 515-520 may occur for various reasons. For example, the track 505b may be initiated on demand, by personnel that operate the system 100. In another example, step 515 may be triggered on a repeating basis (such as quarterly or monthly), or according to an irregular set or variable schedule. Accordingly, the sequence 515-520 may be initiated repeatedly, each time starting at 515.

In step 516, the rollup engine 106d considers all scored claims of the client 112 (obtained from 118), and summarizes them by selected entity such as prescriber or pharmacy or patient. Optionally, the summary may be broken down by individual patient-drug combination, or individual drugs or drug families. For the entity that is the subject of this summary, step 516 prepares a combined entity score based upon the scores of the individual, summarized claims. This report may detail, for example, the number and type of suspicious claims associated with the selected entity. The summary of step 516 may employ the same areas prescribed by the metrics of step 503, and may also include different metrics particular to entities rather than patients.

In one example, step 516 separately sums the metric-specific sub-score for all claims pertaining to the entity of interest, and divides them by the number of claims to yield a separate score for the entity, per-metric. Then, the per-metric scores are combined by taking the maximum or another method. In a simpler example, step 516 simply sums the final scores for all claims pertaining to the entity of interest, and divides them by the number of claims. In still another example, step 516 examines the paid claims data 118 to find the statistical distribution of all entity's scores, then step 516 ranks the individual entities according to their percentile.

In step 518, the rollup engine 106d prepares a report representing the results of step 516. In one example, this report includes a ranking of all entities (such as pharmacies or prescribers or patients) with the poorest scoring entities at top. The report may be organized according to combined score, percentile, or any other evaluation measurement that will be familiar to those skilled in the art having the benefit of this disclosure. This gives the client 102 a clear picture of which entities might warrant audits or other investigation. The report may contain information such as aggregation of the claim level metrics, total volume of claims, total dollars paid, total drug concentrations, etc.

In step 520, the rollup engine 106d sends the report of step 518 to the client 102 via the relay 112. Alternatively, the system 100 may transmit the report 112a directly to the client 102 via U.S. mail, courier, package delivery service, facsimile, email, worldwide web site, secure HTTPS download by the interface 117, or any other service adequate to convey the information.

After step 520, the client 102 may take various actions that are not part of the system 100 and the sequence 500 but still merit discussion. For example, the client 102 may act on the report of 520 by conducting its own investigation of a patient, prescriber, healthcare institution, hospital, or other entity in order to prevent this and future losses. Other post-reporting 520 action by the client 102 may include gathering information for a potential audit, and targeting certain pharmacies, prescribers, or health care institutions for audit, education, and other forms of intervention.

Billing

Dependent upon whether the system 100 is implemented in-house at the client 102, there may be additional operations regarding billing of the client 102. And, even if the system 100 is implemented in-house, billing may be desirable to track utilization of the system 100 for purposes of company accounting, resource utilization reports, etc.

In one case, billing is conducted by a completely different processing entity than the analysis module 106. In another case, billing is conducted by software in the module 106 in order to conserve computing resources. In one example, the system 100 bills the client 102 a fixed cost, such as $0.02 each time the client 102 submits a pending pharmacy claim (in step 506). Similarly, the system 100 may charge $10,000 or a different amount upon preparing each historical analysis 518. In a different example, rather than per-use fees, the system 100 may invoice the client a flat fee upon monthly, quarterly, annual, or other basis. In another example, the system 100 may perform the sequence 500 for the client 102 without charge, except for a per-transaction charge upon each client retrieval of a scored claim 110a, rollup report 112a, and/or advice 109a. In another example, the client 102 pays a contingent fee based upon the amount of non-meritorious claims, errors, instances of fraud, or other nonstandard activity revealed by the reports 112a and scored claims 110a.

### Other Embodiments

While the foregoing disclosure shows a number of illustrative embodiments, it will be apparent to those skilled in the art that various changes and modifications can be made herein without departing from the scope of the invention as defined by the appended claims. Accordingly, the disclosed embodiment are representative of the subject matter which is broadly contemplated by the present invention, and the scope of the present invention fully encompasses other embodiments which may become obvious to those skilled in the art, and that the scope of the present invention is accordingly to be limited by nothing other than the appended claims.

All structural and functional equivalents to the elements of the above-described embodiments that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for” or, in the case of a method claim, the phrase “step for.”

Furthermore, although elements of the invention may be described or claimed in the singular, reference to an element in the singular is not intended to mean “one and only one” unless explicitly so stated, but shall mean “one or more”. Additionally, ordinarily skilled artisans will recognize that operational sequences must be set forth in some specific order for the purpose of explanation and claiming, but the present invention contemplates various changes beyond such specific order.

In addition, those of ordinary skill in the relevant art will understand that information and signals may be represented using a variety of different technologies and techniques. For example, any data, instructions, commands, information, signals, bits, symbols, and chips referenced herein may be represented by voltages, currents, electromagnetic waves, magnetic fields or particles, optical fields or particles, other items, or a combination of the foregoing.

Moreover, ordinarily skilled artisans will appreciate that any illustrative logical blocks, modules, circuits, and process steps described herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In another example, the processor and the storage medium may reside in an ASIC.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A computer-implemented method for processing benefits payment claims for prescription medicine, comprising operations of:
receiving pharmacy benefits payment claims submitted for payment by a pharmacy benefits claims payor, each claim specifying a patient-drug combination;
for each claim, performing operations comprising:
performing computer-driven statistical analysis of predefined aspects of a claims history for the specified patient-drug combination in relation to a history of claims paid by the pharmacy benefits claims payor involving a multiplicity of different patients and drugs;
generating an indicator of predicted legitimacy by scoring results of the statistical analysis;
providing an output of at least one of the following: the indicator, payment advice prepared by applying predefined criteria to data including the indicator.

2. A computer-implemented method for processing benefits payment claims for prescription medicine, comprising operations of:
receiving pending pharmacy benefits payment claims submitted for payment by a pharmacy benefits claims payor, each claim specifying a patient;
for each claim and its specified patient, performing operations comprising:
performing computer-driven statistical analysis of predefined aspects of one of the following in relation to a compiled history of past claims paid by one or more pharmacy benefits claims payors:
claims history for the patient, the claim, medical history of the patient;
generating an indicator of predicted legitimacy by scoring results of the statistical analysis;
providing an output of at least one of the following: the indicator, payment advice prepared by applying predefined criteria to data including the indicator.

3. The method of claim 2, where the operation of performing statistical analysis comprises:
computing predetermined metrics quantitatively describing characteristics specified by predefined schemas;
comparing the computed metrics to the compiled history and producing a statistical ranking of the metrics according to the comparison.

4. The method of claim 3, where the schemas include at least one of:
occurrence of an unusual combination of drugs prescribed together;
occurrence of a patient visiting multiple pharmacies in the same day;
occurrence of dollars paid for a given prescribed drug;
occurrence of simultaneous prescriptions for drugs in the same therapeutic class;
occurrence of a patient having prescriptions from multiple prescribers for a single medicine;
occurrence of a patient receiving a large dollar value worth of the same or different drugs on the same day;
occurrence of a patient receiving an unusually high supply of a drug over a period of time;
occurrence of a patient taking a non-maintenance drug for an unusually long period of time.

5. The method of claim 3, where the schemas include all of:
rate drug use;
total expense of all medicines prescribed for a patient per day;
occurrence of prescriptions for medicines in same therapeutic class;
expense of patient's prescription;
concurrent prescriptions for one patient involving one or more of the following:
multiple pharmacies, multiple prescribers;
excess supply of a drug over a period of time.

6. The method of claim 2, where the generating operation comprises one of the following:
(1) separately scoring results of the statistical analysis as to each of the one or more predefined aspects;
(2) separately scoring results of the statistical analysis as to each of the one or more predefined aspects, and computing a final store by combining the separate scores.

7. The method of claim 2, where the operations further comprise:
computing metrics quantitatively describing characteristics of a multiplicity of patient histories contained in the compiled history, where the characteristics are specified by predetermined schema;
generating baseline data by comparing the computed metrics to the compiled history and producing a statistical ranking of the metrics according to the comparison;
where the operation of performing computer-driven statistical analysis comprises comparing the predefined aspects in relation to the baseline data.

8. The method of claim 2, where the operation of providing the output comprises:
for each pharmacy benefit claims payor, queuing output records representative of the indicators and making the queued output records available for on-demand retrieval by the payor via worldwide web interface.

9. The method of claim 2, the operations further comprising:
combining the scored results applicable to a given entity to score for the entity, where each entity is one of the following: prescriber, pharmacy, healthcare institution.

10. The method of claim 2, the payment advice comprising a recommendation as to whether to pay the claim.

11. A computer-driven apparatus to process payment claims for prescription medicine, comprising:
an interface receiving pharmacy benefits payment claims submitted for payment by a pharmacy benefits claims payor, each claim specifying a patient-drug combination;
a computer-driven analysis module programmed to perform operations for each claim, comprising:
performing computer-driven statistical analysis of predefined aspects of a claims history for the specified patient-drug combination in relation to a history of claims paid by the pharmacy benefits claims payor involving a multiplicity of different patients and drugs;
generating an indicator of predicted legitimacy by scoring results of the statistical analysis;
providing an output of at least one of the following: the indicator, payment advice prepared by applying predefined criteria to data including the indicator.

12. A computer-driven apparatus to process payment claims for prescription medicine, comprising:
interface means for receiving pending pharmacy benefits payment claims submitted for payment by a pharmacy benefits claims payor, each claim specifying a patient;
computer-driven analysis means for performing operations for each claim and its specified patient, comprising:
performing computer-driven statistical analysis of predefined aspects of one of the following in relation to a compiled history of past claims paid by one or more pharmacy benefits claims payors:
claims history for the patient, the claim, medical history of the patient;
generating an indicator of predicted legitimacy by scoring results of the statistical analysis;
providing an output of at least one of the following: the indicator, payment advice prepared by applying predefined criteria to data including the indicator.

13. A computer-driven apparatus to process prescription payment claims, comprising:
at least one interface to receive pharmacy benefits payment claims submitted for payment by a pharmacy benefits claims payor, each claim including specification of a patient;
first digital data storage containing a compiled history of past claims paid by one or more pharmacy benefits claims payors;
second digital data storage containing multiple schemas each defining a condition as to one of the following: patient claims history, payment claim, patient medical history;
a metrics engine programmed to compute metrics by applying the schemas to data of at least one of the following in conjunction with a patient:
patient claims history, payment claim, patient medical history, bulk data;
a baseline engine to receive metrics computed for substantially all patients in the compiled history and produce baseline data comprising a statistical analysis of the received metrics in relation to the bulk data;
scoring engine programmed to process a claim received at the interface by performing operations comprising:
receiving metrics computed for a patient specified by the received claim;
statistically analyzing the received metrics against the compiled history;
generating an indicator of predicted legitimacy by scoring results of the statistical analysis;
providing an output of at least one of the following: the indicator, payment advice prepared by applying predefined criteria to data including the indicator.

14. A computer-driven apparatus to process payment claims for prescription medicine, comprising:
an interface receiving pending pharmacy benefits payment claims submitted for payment by a pharmacy benefits claims payor, each claim specifying a patient;
a computer-driven analysis module programmed to perform operations for each claim and its specified patient, comprising:
performing computer-driven statistical analysis of predefined aspects of one of the following in relation to a compiled history of past claims paid by one or more pharmacy benefits claims payors:
claims history for the patient, the claim, medical history of the patient;
generating an indicator of predicted legitimacy by scoring results of the statistical analysis;
providing an output of at least one of the following: the indicator, payment advice prepared by applying predefined criteria to data including the indicator.

15. The apparatus of claim 14, where the analysis module is programmed such that the operation of performing statistical analysis comprises:
computing predetermined metrics quantitatively describing characteristics specified by predefined schemas;
comparing the computed metrics to the compiled history and producing a statistical ranking of the metrics according to the comparison.

16. The apparatus of claim 14, where the analysis module is programmed such that the schemas include at least one of:
occurrence of an unusual combination of drugs prescribed together;
occurrence of a patient visiting multiple pharmacies in the same day;
occurrence of dollars paid for a given prescribed drug;
occurrence of simultaneous prescriptions for drugs in the same therapeutic class;
occurrence of a patient having prescriptions from multiple prescribers for a single medicine;
occurrence of a patient receiving a large dollar value worth of the same or different drugs on the same day;
occurrence of a patient receiving an unusually high supply of a drug over a period of time;
occurrence of a patient taking a non-maintenance drug for an unusually long period of time.

17. The apparatus of claim 14, where the analysis module is programmed such that the schemas include all of:
rate drug use;
total expense of all medicines prescribed for a patient per day;
occurrence of prescriptions for medicines in same therapeutic class;
expense of patient's prescription;
concurrent prescriptions for one patient involving one or more of the following:
multiple pharmacies, multiple prescribers;
excess supply of a drug over a period of time.

18. The apparatus of claim 14, where the analysis module is programmed such that the generating operation comprises one of the following:
(1) separately scoring results of the statistical analysis as to each of the one or more predefined aspects;
(2) separately scoring results of the statistical analysis as to each of the one or more predefined aspects, and computing a final store by combining the separate scores.

19. The apparatus of claim 14, where the analysis module is programmed such that the operations further comprise:
computing metrics quantitatively describing characteristics of a multiplicity of patient histories contained in the compiled history, where the characteristics are specified by predetermined schema;
generating baseline data by comparing the computed metrics to the compiled history and producing a statistical ranking of the metrics according to the comparison;
where the operation of performing computer-driven statistical analysis comprises comparing the predefined aspects in relation to the baseline data.

20. The apparatus of claim 14, where the analysis module is programmed such that the operation of providing the output comprises:
for each pharmacy benefit claims payor, queuing output records representative of the indicators and making the queued output records available for on-demand retrieval by the payor via worldwide web interface.

21. The apparatus of claim 14, the analysis module is programmed such that the operations further comprise:
combining the scored results applicable to a given entity to score for the entity, where each entity is one of the following: prescriber, pharmacy, healthcare institution.

22. The apparatus of claim 14, the analysis module is programmed such that the payment advice comprises a recommendation as to whether to pay the claim.
